(19) United States
(12) Patent Application Publication
(10) Pub. No.: US 2011/0073501 A1
(43) Pub. Date: Mar. 31, 2011

(54) CONTAINER FOR ACCOMMODATING DIFFERENT INJECTION MEDICINES

(76) Inventor: Kuo Cheng WU, Kaohsiung City (TW)

(21) Appl. No.: 12/683,858

(22) Filed: Jan. 7, 2010

Related U.S. Application Data
(60) Provisional application No. 61/272,717, filed on Oct. 26, 2009.

(30) Foreign Application Priority Data
Sep. 29, 2009 (TW) 098132936

(51) Int. Cl. A61J 1/14; B65D 25/08

(52) U.S. Cl. 206/219; 604/403

(57) ABSTRACT

A container for accommodating different injection medicines comprises a first vessel, a second vessel and a partition disk. First vessel is an integral hollow cylinder sandwiched between a pair of intercommunicatable top surface and bottom surface. Second vessel of integral hollow cylinder includes a first holding compartment therein encompassed by an open top surface, a closed bottom surface and a sidewall. Partition disk is padded under the bottom of the first vessel. Partition disk and lower section of first vessel are inserted into upper section of second vessel. Thereby, different injections can be temporarily held in separated compartments respectively without intermixing. When injection administration is required, blending procedure is well hermetically finished in the vial without any syringe needle. Thereby, not only entire blending procedure meets aseptic requirement, but also accidence for the healthcare personnel being pierced by such syringe needle is completely eliminated.

This application claims the benefit of provisional U.S. Patent Application No. 61/272,717, field Oct. 26, 2009.

### FIELD OF THE PRESENT INVENTION

The present invention relates to a container for accommodating different injection medicines, particularly for one that different injections can be temporarily held in separated compartments respectively without any possibility of intermixing. When injection administration is required, blending procedure can be well hermetically finished in the container without any syringe needle serving as blending tool. Thereby, not only the entire blending procedure meets the requirement of aseptic manipulation without any contamination, but also the risk for the healthcare personnel being accidentally pierced by such syringe needle can be completely eliminated.

### BACKGROUND OF THE INVENTION

Please refer to FIGS. 1 through 3. The injection vial, which is currently used in hospitals and clinics, comprises a vial body 10, a septum stopper 20 and a crimp cap 30, wherein said vial body 10, which is a hollow cylinder, includes a round opening 11, an interior hollow cavity 12 being able to intercommunicate with the round opening 11, and a reduced vial neck 13 disposed under the round opening 11; said septum stopper 20, which is made of high density elastic rubber of nontoxic material, includes a planar top round surface 21 and a downward bottom obturating plug 22 such that the outer diameter of the top round surface 21 equals that of the round opening 11 at vial body 10, and the downward bottom obturating plug 22 can insert into the round opening 11 of vial body 10 in watertight manner; and said crimp cap 30, which is punched by thin metal foil into round hollowed-out block, has an injection molded plastic safety cover 31 hooded thereon. When prescribed liquid injection medicament R is filled into the interior hollow cavity 12 of vial body 10, firstly clog the vial body 10 by inserting the bottom obturating plug 22 of the septum stopper 20 into the round opening 11 of the vial body 10, then cap the crimp cap 30 over the septum stopper 20 such that an inwardly tuck-under thereof closely contact against the reduced vial neck 13 of the vial body 10 so that the prescribed liquid injection medicament R is hermetically contained in the interior hollow cavity 12 without any possibility to leak out of the vial body 10 (as shown in the FIG. 3).

Taking the hypodermic injection of 5-oxo-prolyl-histidyl-tryptophyl-seryl-tyrosyl-D-leucyl-leucyl-arginyl-N-ethyl-prolinamide monoacetate, which can be injected in the patients of breast cancer and prostate cancer as curing medication by the prescription of the authorized doctors, from the Takeda Pharmaceutical Company Limited (Japan) as example, the delivery package includes a vial for containing light yellow powder Leuprorelin acetate medicament and a glass ampoule for containing medicament solvent. Thereby, the final injection from the mixture of the power Leuprorelin acetate medicament and the medicament solvent can be prepared and blended in the vial body 10 before injecting administration. The preparing and blending steps are depicted as shown in the FIGS. 4 through 9. a. Firstly break the neck of the glass ampoulel containing medicament solvent by bending force of the holding fingers (as shown in the FIG. 4); b. Insert and extend syringe needle 3 into the glass ampoulel for sucking the liquid injection medicament R1 of solvent contained therein into syringe 2 (as shown in the FIG. 5); c. Hook any margin of the safety cover 31 on the vial 10 containing powder Leuprorelin acetate medicament S by the finger(s) and lift up to detach the safety cover 31 off the crimp cap 30 by upwards force (as shown in the FIG. 6); d. Pierce through the septum stopper 20 by the syringe needle 3 and extend it into the interior hollow cavity 12 of vial 10 for squeezing out all the liquid injection medicament R1 in syringe 2 so that the powder Leuprorelin acetate medicament S can be solved by the solvent of the liquid injection medicament R1 in the interior hollow cavity 12 (as shown in the FIG. 7); e. Shake the vial 10 after pulling the syringe needle 3 thereat out for several time so as to let the powder Leuprorelin acetate medicament S can be completely solved by the solvent of the liquid injection medicament R1 to become a final medicated liquid injection M1 (as shown in the FIG. 8); and f. Finally, re-insert and extend syringe needle 3 into the vial body 10 for sucking out all the medicated liquid injection M1 into syringe 2 to serve as hypodermic injection medication for the patients (as shown in the FIG. 9).

Following issues are found in the preparing and blending steps depicted above. A syringe 2 and a syringe needle 3 are used as preparing and blending tools in steps b and d, the risk of contamination and bacteria invasion into the powder Leuprorelin acetate medicament S or the solvent of the liquid injection medicament R1 may possibly exist depending on the degree of the concentration and dexterity of each healthcare personnel so that any inadvertent operation will be unable to meet the requirement of overall aseptic manipulation. Besides, the healthcare personnel might be accidentally pierced by the syringe needle 3 in steps b and d.

Moreover, each glass ampoulel containing solvent of liquid injection medicament R1 and each vial body 10 containing powder Leuprorelin acetate medicament S, which are always fabricated under the different manufacturing schedule by related pharmaceutical factory instead of being fabricated at same time, have each different self-life of their own so that medical organization must carefully recognize each marked self-life thereon by human-eye vision in inventory management. Besides, healthcare personnel must also inspect each marked self-life thereon by human-eye vision before preparing and blending procedure to confirm the validity of medicated liquid injection M1, otherwise the medicated liquid injection M1 may fail to produce medication effect due to expiry of the shelf-life.

Furthermore, as shown in the FIGS. 10 through 12, certain other medicated liquid injection M2 contains first liquid injection medicament R2 and second liquid injection medicament R3, each of which is filled in each different vial body 10a and vial body 10b respectively. The blending steps before hypodermic injection administration are depicted below. a. Insert and extend syringe needle 3 into the vial body 10a for sucking the first liquid injection medicament R2 contained therein into syringe 2 (as shown in the FIG. 10); b. Insert and extend syringe needle 3 into the interior hollow cavity 12b of vial 10b for squeezing out all the first liquid injection medicament R2 in syringe 2, next pull the syringe needle 3 thereat out (as shown in the FIG. 11); then shake the vial 10b for several time so as to let the first liquid injection medicament R2 can be completely blended by the second liquid injection medicament R3 in the interior hollow cavity 12b to become a final medicated liquid injection M2; and c. Finally, re-insert and extend syringe needle 3 into the interior hollow cavity 12b of vial body 10b for sucking out all the medicated liquid injection M2 into syringe 2 to serve as hypodermic injection medication for the patients (as shown in the FIG. 12). Similarly, following issues are found in the preparing and blending steps depicted above. A syringe 2 and a syringe needle 3 are also used as preparing and blending tools in steps a through c, the healthcare personnel might also be accidentally pierced by the syringe needle 3, and the risk of contamination and bacteria invasion into the first liquid injection medicament R2 or the second liquid injection medicament R3 may possibly exist depending on the degree of the concentration and dexterity of each healthcare personnel too.

Moreover, other than each of first liquid injection medicament R2 and second liquid injection medicament R3 is respectively filled in each of vial body 10a and vial body 10b, each of opening 11a and opening 11b on each of interior hollow cavity 12a and interior hollow cavity 12b needs each of a septum stopper 20 and a crimp cap 30 so that the medical organization are forced to pay extra expense for such an extra septum stopper 20 and crimp cap 30. In total global calculation, annual extra expense for such an extra septum stopper 20 and crimp cap 30 will be a considerable amount. Besides, the wasted such an extra septum stopper 20 and crimp cap 30 will become an extra burden for environmental protection.

Accordingly, how to solve all the issues aforesaid becomes an urgent task. Having realized and addressed this fact, the applicant of the present invention has enthusiastically undertaken research and development. Eventually, the expected contrivance of the present invention is successfully worked out.

### SUMMARY OF THE INVENTION

The primary object of the present invention is to provide a container for accommodating different injection medicines basically comprising a first vessel, a second vessel and a partition disk, wherein the first vessel is an integral hollow cylinder sandwiched between a pair of top surface and bottom surface, which are able to intercommunicate each other; the second vessel of integral hollow cylinder includes a first holding compartment therein encompassed by an open top surface, a closed bottom surface and a cylindrical sidewall; the partition disk is padded under the bottom of the first vessel; and the partition disk and the lower section of the first vessel are inserted into the upper section of the second vessel. Thereby, by separation of the partition disk, a first liquid or powder injection medicament contained in the second vessel and a second liquid injection medicament contained in the first vessel can be temporarily held in separated compartments respectively without any possibility of intermixing. When injection administration is required, a downwards force is exerted on the first vessel to push the partition disk drop into the second vessel so that the second liquid injection medicament and the first liquid or powder injection medicament can be well blended in the second vessel to become a hypodermic injection medication for the patients. Because the entire blending procedure of the first liquid or powder injection medicament and second liquid injection medicament is proceeded in the hermitical vial without any exposure to ambient air, no possibility of contamination and bacteria invasion will exist. Thus, the entire blending procedure meets the requirement of aseptic manipulation. Besides, because no syringe needle or other sharp article is served as blending tool, the risk for the healthcare personnel being accidentally pierced by such syringe needle or other sharp article can be completely eliminated to ensure a better safety protection.

The other object of the present invention is to provide a container for accommodating different injection medicines having a partition disk and a safety binding hoop with plural raised lining pads applied to inner surface thereof in a recurring pattern created between the first vessel and second vessel to serve as fixing jointer. Thereby, only single set of conventional septum stopper and crimp cap to required to achieve expected packaging effect after completion for the filling procedure of the first liquid or powder injection medicament and second liquid injection medicament so that not only the demanding quantity of the septum stopper and crimp cap can be economically saved, but also the burden for environmental protection in the wasted septum stopper and crimp cap can be reduced.

### BRIEF DESCRIPTION OF THE DRAWINGS

FIG. 1 is an exploded perspective view for the conventional injection vial.

FIG. 2 is an assembled schematic view for the conventional injection vial.

FIG. 3 is a sectional view taken along line 3-3 as indicated in FIG. 2.

FIG. 4 is a schematic view for the conventional injection ampoule.

FIG. 5 is an illustrative schematic view showing the suction of liquid medicament from the conventional injection ampoule by a syringe needle.

FIG. 6 is an illustrative schematic view showing the opening for the conventional injection vial containing powder medicament.

FIG. 7 is the first operational schematic view showing the blend of two different medicaments for the conventional injection vial.

FIG. 8 is the second operational schematic view showing the blend of two different medicaments for the conventional injection vial.

FIG. 9 is the third operational schematic view showing the blend of two different medicaments for the conventional injection vial.

FIG. 10 is the fourth operational schematic view showing the blend of two different medicaments for the conventional injection vial.

FIG. 11 is the fifth operational schematic view showing the blend of two different medicaments for the conventional injection vial.

FIG. 12 is an illustrative schematic view showing the suction of blended injection mixture from the conventional injection vial by a syringe needle.

FIG. 13 is an exploded perspective view of a container for accommodating different injection medicines according to a first preferred embodiment of the present invention.

FIG. 14 is a sectional view taken along line 14-14 as indicated in FIG. 13.

FIG. 15 is a sectional view taken along line 15-15 as indicated in FIG. 13.

FIG. 16 is a sectional view taken along line 16-16 as indicated in FIG. 13.

FIG. 17 is the first operational schematic view showing the assembly and fill medicament for the above first preferred embodiment of the present invention.

FIG. 18 is the second operational schematic view showing the assembly and fill medicament for the above first preferred embodiment of the present invention.

FIG. 19 is the third operational schematic view showing the assembly and fill medicament for the above first preferred embodiment of the present invention.

FIG. 20 is the fourth operational schematic view showing the assembly and fill of two different medicaments for the above first preferred embodiment of the present invention.

FIG. 21 is the fifth operational schematic view showing the assembly and fill of two different medicaments for the above first preferred embodiment of the present invention.

FIG. 22 is the first operational schematic view showing the blend and suction of blended injection mixture from the above first preferred embodiment of the present invention.

FIG. 23 is the second operational schematic view showing the blend and suction of blended injection mixture from the above first preferred embodiment of the present invention.

FIG. 24 is the third operational schematic view showing the blend and suction of blended injection mixture from the above first preferred embodiment of the present invention.

FIG. 25 is the fourth operational schematic view showing the blend and suction of blended injection mixture from the above first preferred embodiment of the present invention.

FIG. 26 is the fifth operational schematic view showing the blend and suction of blended injection mixture from the above first preferred embodiment of the present invention.

FIG. 27 is a sectional view of the above first preferred embodiment of the present invention having a modified partition disk with an additional annular parapet.

FIG. 28 is an assembly sectional view showing a modified partition disk with an additional annular sealing ledge in the above first preferred embodiment of the present invention.

FIG. 29 is a sectional view of the annular sealing ledge for the above first preferred embodiment of the present invention as showing in FIG. 28.

FIG. 30 is a sectional plan view of a second vessel of the container of the present invention.

FIG. 31 is a sectional view taken along line 31-31 as indicated in FIG. 30.

FIG. 32 is an operational schematic sectional view showing blended injection mixture from the above second vessel container of the present invention.

FIG. 33 is a sectional plan view of a further modified partition disk with additional round dent of the present invention.

FIG. 34 is an assembly sectional view showing a further modified partition disk with an additional round dent of the present invention.

FIG. 35 is a disintegrated sectional view showing the container with additional coupling threads in the sixth exemplary embodiment of the present invention.

FIG. 36 is an assembly sectional view showing a container with additional coupling threads in the sixth exemplary embodiment of the present invention.

FIG. 37 is a sectional view showing a middle third vessel with a second partition disk being added in a container as the seventh exemplary embodiment of the present invention.

FIG. 38 is an isolated sectional view showing the second partition disk in a container as the seventh exemplary embodiment of the present invention.

FIG. 39 is an assembly perspective view showing a middle third vessel with a second partition disk being added in a container as the seventh exemplary embodiment of the present invention.

FIG. 40 is a cross sectional view taken along line 40-40 as indicated in FIG. 39.

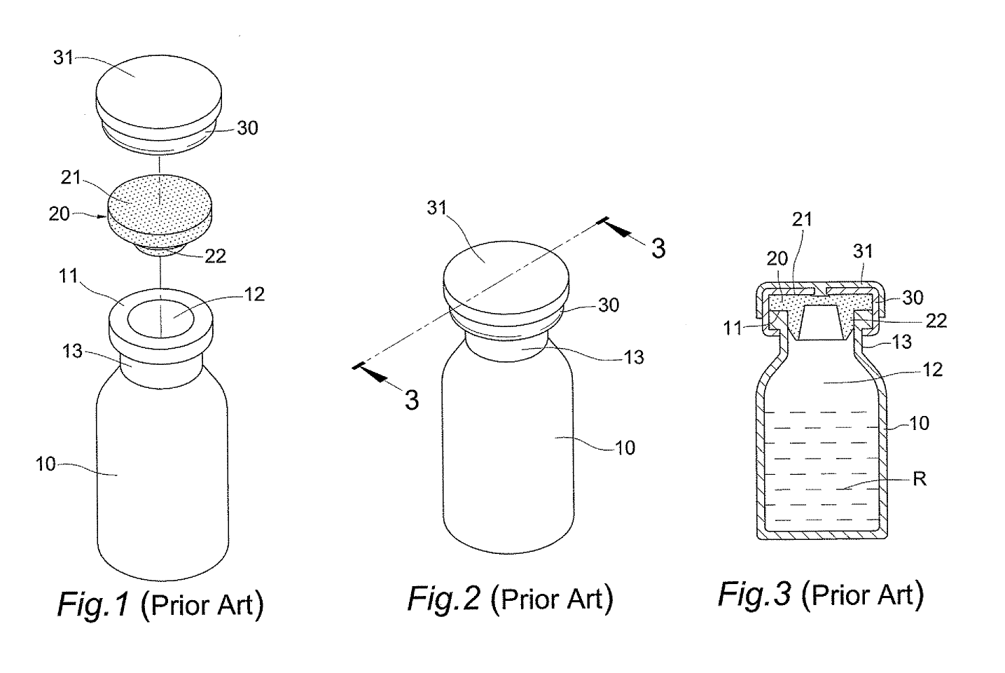

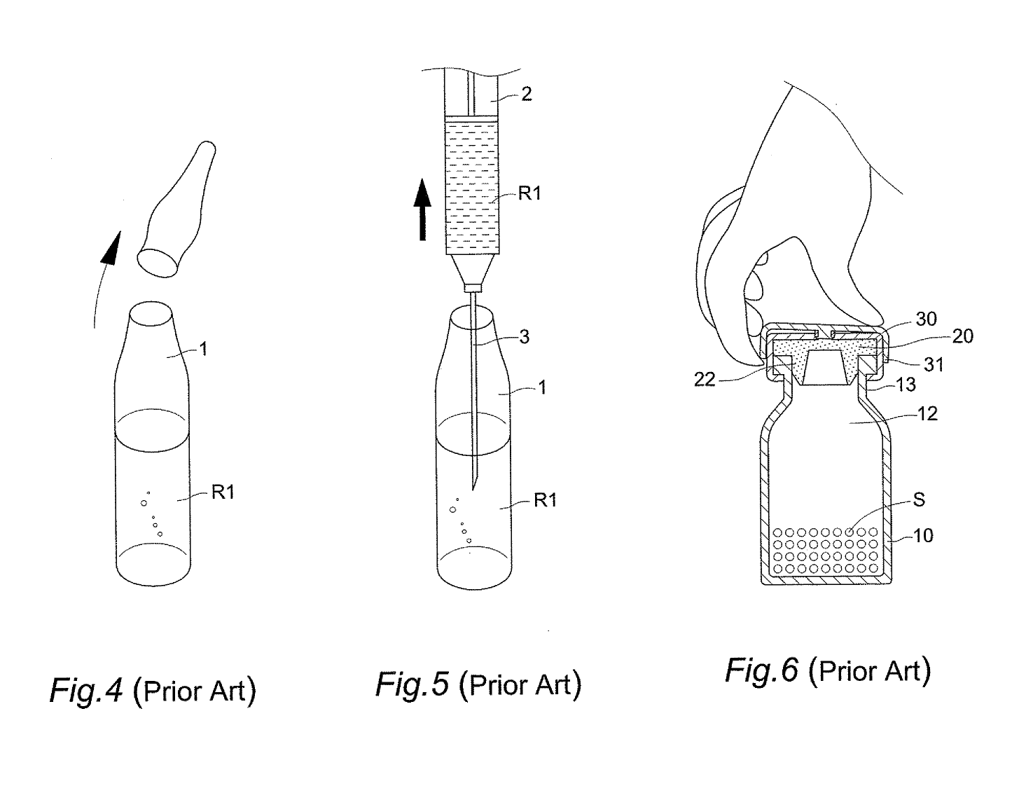

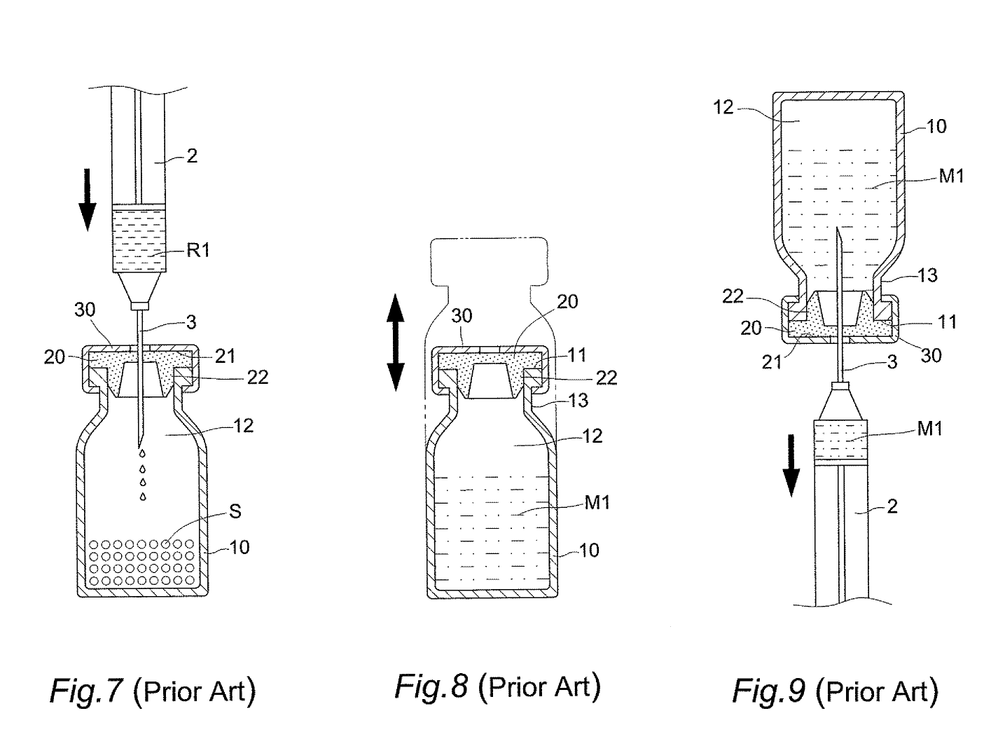

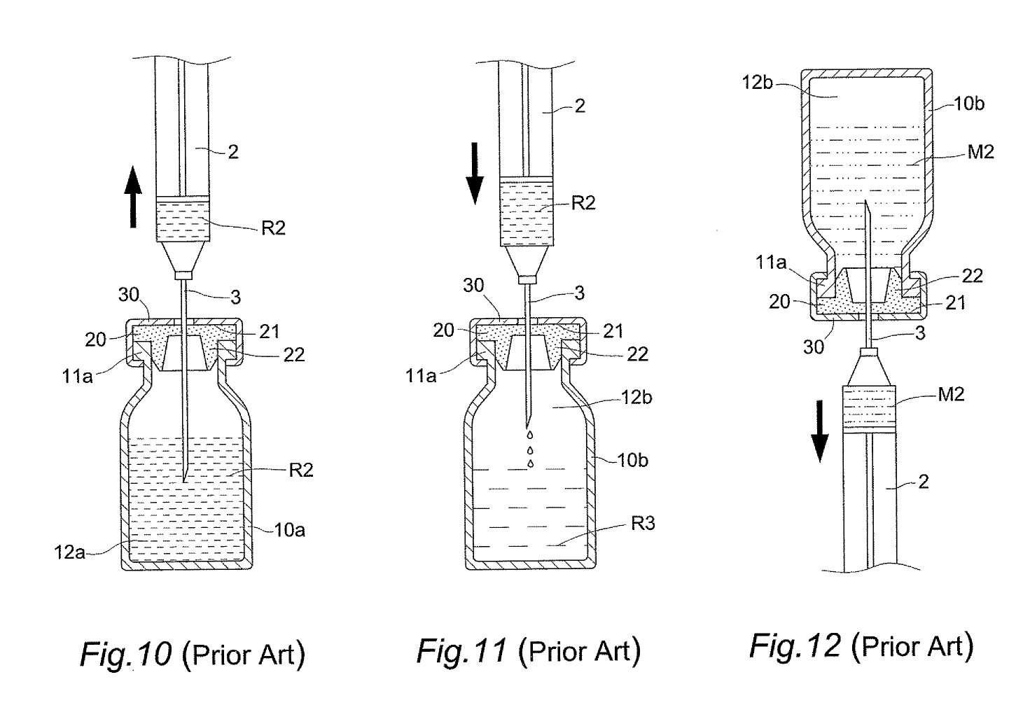

### DETAILED DESCRIPTION OF THE PREFERRED EMBODIMENTS

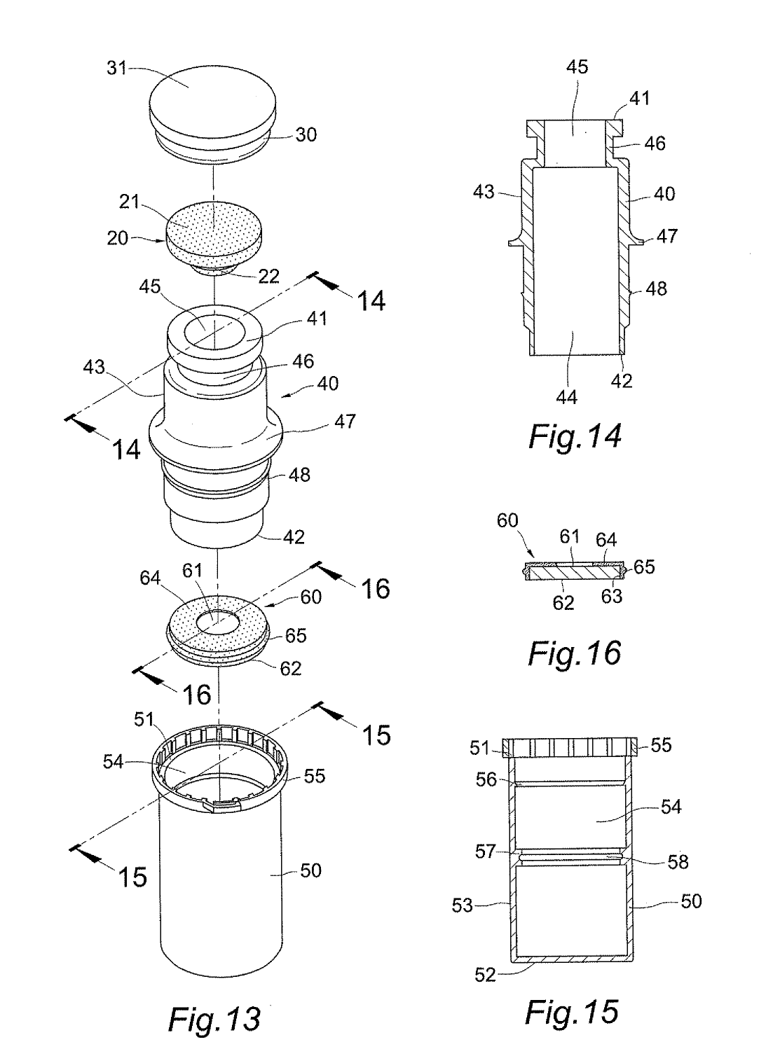

Referring to FIGS. 13 through 21, a container for accommodating different injection medicines according to a first preferred embodiment of the present invention comprises a first vessel 40, a second vessel 50 and a partition disk 60.

Referring to FIGS. 13 to 16 and 21, the first vessel 40 is an integral hollow cylinder, includes a first holding compartment 44 therein encompassed by a top surface 41, a bottom surface 42 and a cylindrical sidewall 43 such that the first holding compartment 44 is able to intercommunicate with the top surface 41 and bottom surface 42; said first holding compartment 44 includes a top opening 45 lying at the top surface 41, a reduced neck 46 disposed near the top surface 41 on the sidewall 43, a baffle flange 47 disposed in the middle periphery of the sidewall 43, and a docking barbed rim 48 disposed in the periphery of the sidewall 43 between the baffle flange 47 and bottom surface 42 so that the top opening 45 can receive the septum stopper 20, and the reduced neck 46 can be closely contact against by an inwardly tuck-under of the crimp cap 30 so that the top opening 45 of the first holding compartment 44 can be clogged by the septum stopper 20 in watertight manner (as shown in the FIG. 21);

The second vessel 50 is an integral hollow cylinder, includes a first holding compartment 54 therein encompassed by an open top surface 51, a closed bottom surface 52 and a cylindrical sidewall 53; said second holding compartment 54, whose inner diameter is slightly bigger than the outer diameter for the sidewall 43 of the first vessel 40, includes a safety binding hoop 55 with plural raised lining pads applied to inner surface thereof in a recurring pattern disposed over the top surface 51, a docking fluked lip 56 created in the inner wall thereof near the top surface 51, a retaining ring mount 57 created in the inner wall thereof about middle section and a latching groove brim 58 created in the central rim of the retaining ring mount 57; and

The partition disk 60 is an integral disk includes a top surface 61 and a bottom surface 62 encompassed by a round sidewall 63, has a soft silica gel layer 64, which wraps over the top surface 61 and sidewall 63, and a latching jut brim 65 outwardly hooped over the soft silica gel layer 64 on the sidewall 63.

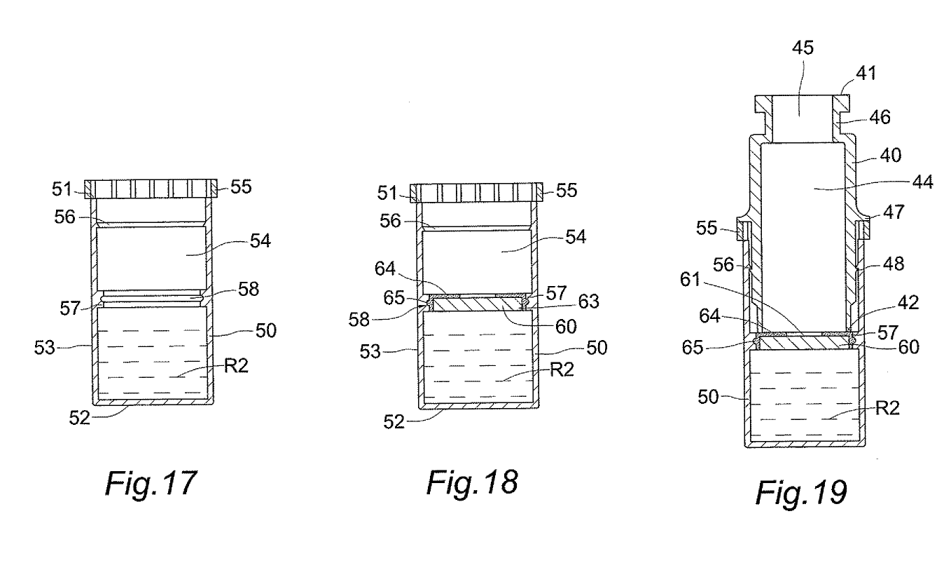

FIGS. 17 through 21 describe the assembling and filling of the above first preferred embodiment of the present invention in steps as follow:

Step a:

First, fill a first liquid injection medicament R2 into the second holding compartment 54 of second vessel 50 (as shown in the FIG. 17);

Step b:

By facing the bottom surface 62 of partition disk 60 towards the bottom surface 52 of second vessel 50, insert the partition disk 60 into the second holding compartment 54 up to state the sidewall 63 of partition disk 60 being inset in the retaining ring mount 57 of second holding compartment 54 so that the latching jut brim 65 outwardly hooped over the soft silica gel layer 64 on the sidewall 63 of partition disk 60 can mutually contact against the latching groove brim 58 of retaining ring mount 57 in watertight manner to prevent any leakage (as shown in the FIG. 18);

Step c:

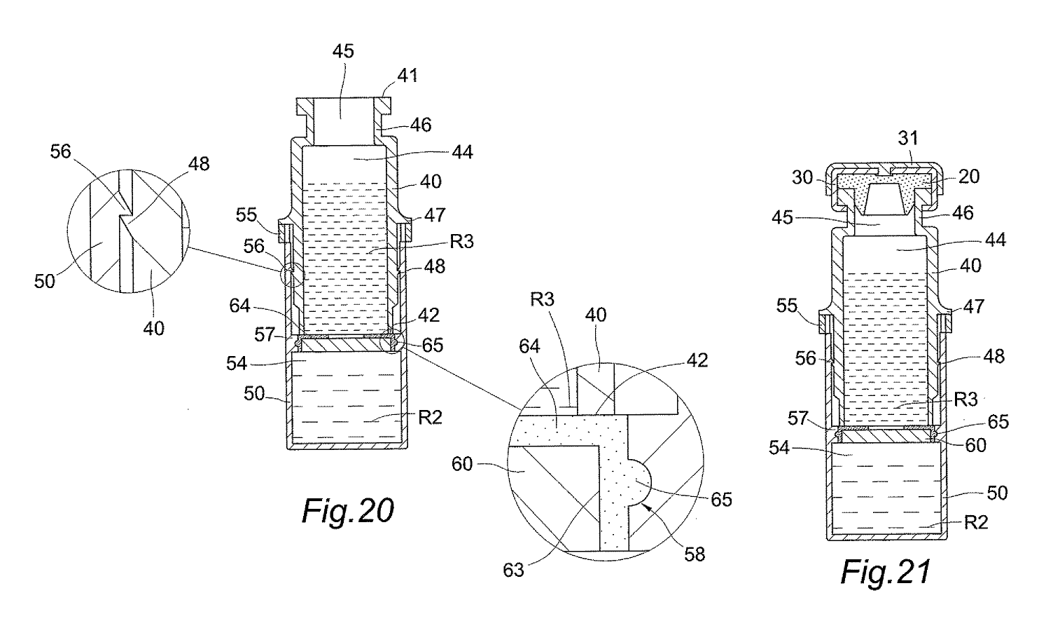

By aligning the bottom surface 42 of first vessel 40 towards the top surface 51 of second vessel 50, insert the first vessel 40 into the second holding compartment 54 up to state the bottom surface 42 of first vessel 40 in contact with the top surface 61 of partition disk 60 so that the docking barbed rim 48 on the cylindrical sidewall 43 of first vessel 40 can mutually contact against the docking fluked lip 56 for the second holding compartment 54 of second vessel 50 in closely locked manner (as shown in the FIG. 19 and left enlarged view of the FIG. 20);

Step d:

Next, fill a second liquid injection medicament R3 into the first holding compartment 44 via the top opening 45 of first vessel 40; At this moment, no leakage from first holding compartment 44 will happen because the bottom surface 42 of first vessel 40 is in closely contact with the soft silica gel layer 64 on the top surface 61 of partition disk 60 (as shown in right enlarged view of the FIG. 20); and

Step e:

Finally, insert the septum stopper 20 into the top opening 45 for the top surface 41 of first vessel 40, then cap the crimp cap 30 over the septum stopper 20 to let an inwardly tuck-under thereof closely contact against the reduced neck 46 of the first vessel 40, thus the entire filling assembly is finished here (as shown in the FIG. 21).

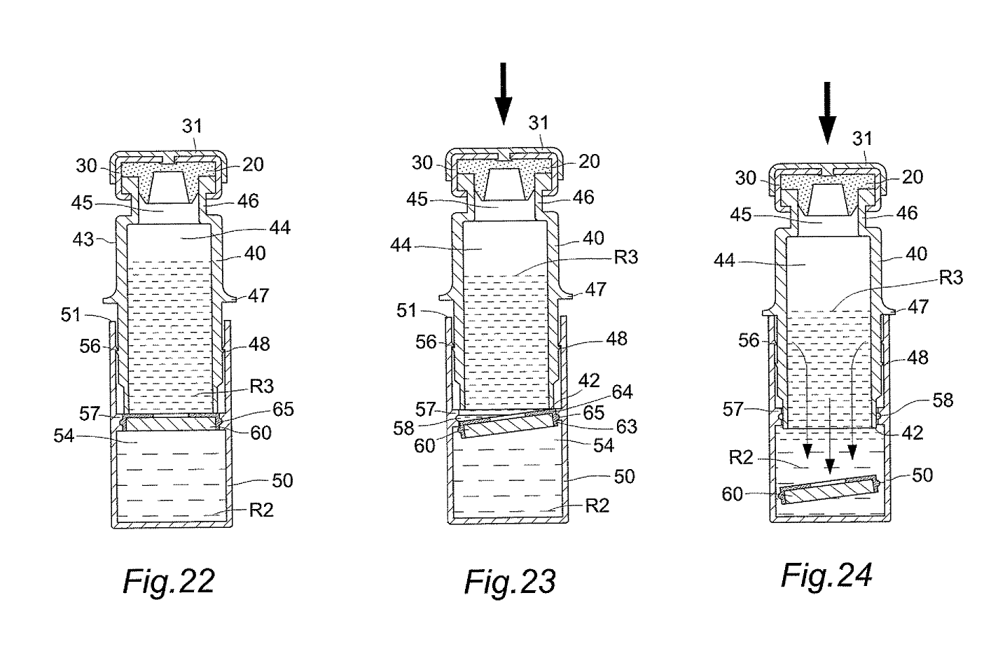

Please further refer to FIGS. 22 through 26. The procedure steps for hypodermic injection of the above first preferred embodiment of the present invention are depicted below:

Firstly, tear off the safety binding hoop 55 on the top surface 51 of second vessel 50 so that a peripheral space with height equivalent to height of the safety binding hoop 55 forms between the baffle flange 47 on the cylindrical sidewall 43 of first vessel and the top surface 51 of second vessel 50 (as shown in the FIG. 22);

Secondly, exert downwards force on the crimp cap 30 to cause the bottom surface 42 of first vessel 40 to push the partition disk 60 so that the sidewall 63 of the partition disk 60 is detached off the retaining ring mount 57 on the second holding compartment 54 of second vessel 50 (as shown in the FIG. 23);

Thirdly, after the partition disk 60 being completely detached off the retaining ring mount 57 and sunk into the second holding compartment 54 of second vessel 50, the second liquid injection medicament R3 in the first holding compartment 44 of first vessel 40 will downwardly flow into the second holding compartment 54 to blend with the first liquid injection medicament R2 therein (as shown in the FIG. 24);

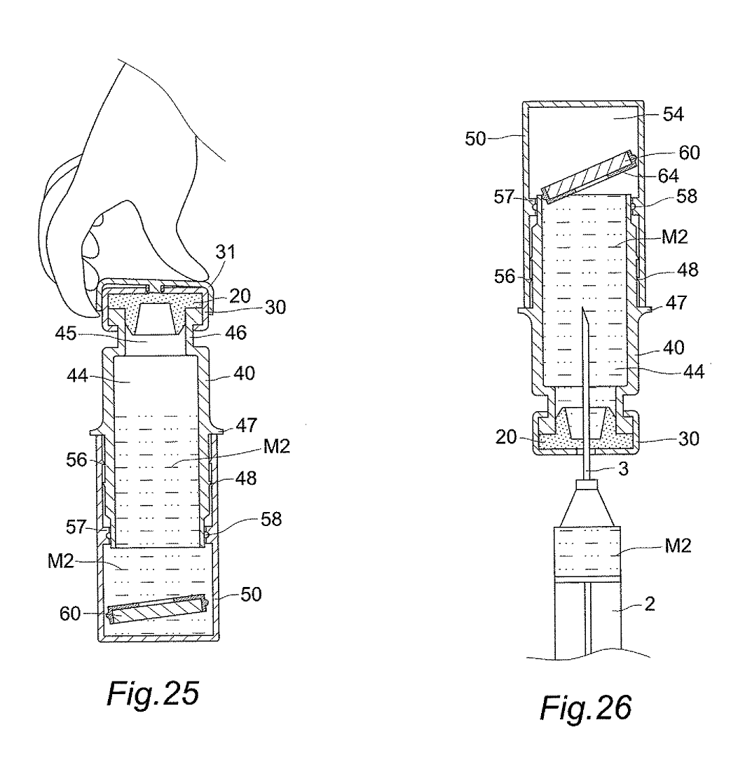

Fourthly, after the first liquid injection medicament R2 and second liquid injection medicament R3 having fully blended each other to become a medicated liquid injection M2, hook any margin of the safety cover 31 on the crimp cap 30 by the finger(s) and lift up to detach the safety cover 31 off the crimp cap 30 by upwards force (as shown in the FIG. 25); and

Finally, pierce through the septum stopper 20 by a syringe needle 3 and extend it into the first holding compartment 44 of first vessel 40 for sucking out all the medicated liquid injection M2 into syringe 2 to serve as hypodermic injection medication for the patients (as shown in the FIG. 26).

Comparing the blending procedure of the present invention depicted above to the conventional prior arts described in the section captioned “BACKGROUND OF THE INVENTION”; there are certain advantages as below. In these procedure steps for hypodermic injection of the present invention, the shelf life of first liquid injection medicament R2 is same as the shelf life of second liquid injection medicament R3 because they are respectively filled in each second vessel 50 and first vessel 40 on the same day. Thereby, the situation that one of them is expired and the other is not expired will never happen. Accordingly, not only the extra cost loss incurred by the discarded medicaments due to expiry of shelf life can be avoided in the medical organizations, but also the purchasing and adopting intention of the medical organizations in the future will be enhanced. Moreover, because the entire blending procedure of the first liquid injection medicament R2 and second liquid injection medicament R3 is proceeded in the hermitical first vessel 40 and second vessel 50 without any exposure to ambient air, no possibility of contamination and bacteria invasion will exist. Thus, the entire blending procedure meets the requirement of aseptic manipulation. Besides, because no syringe needle or other sharp article is served as blending tool, the risk for the healthcare personnel being accidentally pierced by such syringe needle or other sharp article can be completely eliminated to ensure a better safety protection.

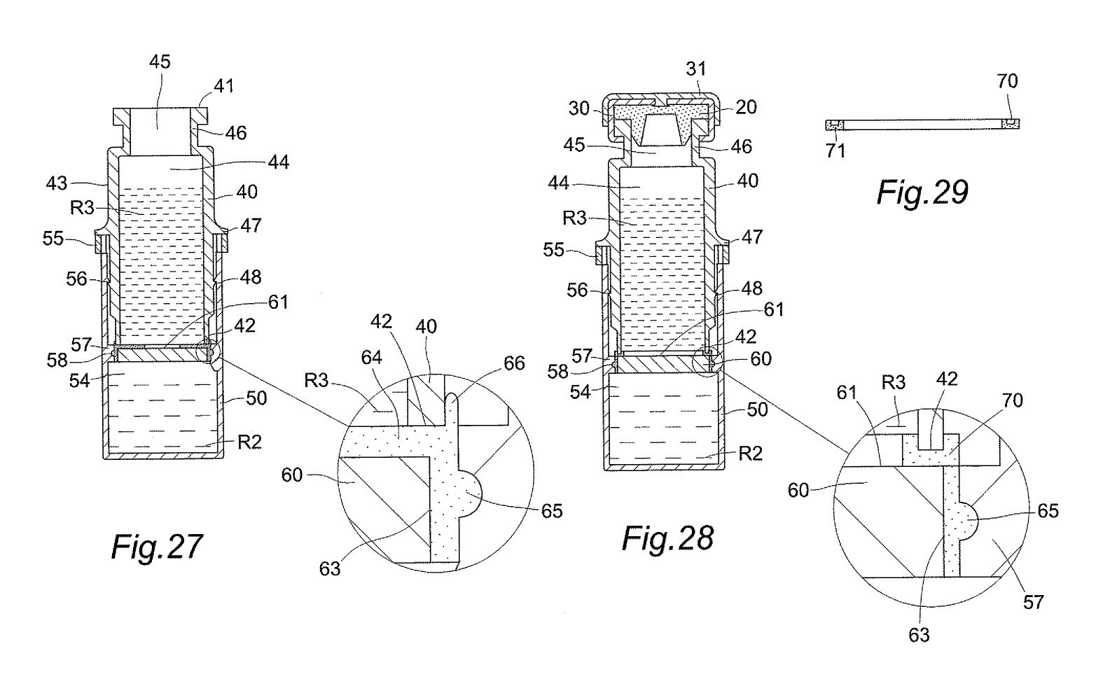

Please refer to FIG. 27, which is an illustrative view showing a container for accommodating different injection medicines according to a second exemplary embodiment of the present invention. Wherein said partition disk 60 with an additional annular parapet 66 disposed on the outmost edge of the soft silica gel layer 64 over the top surface 61 of partition disk 60 (as shown in enlarged view of the FIG. 27) so that the partition disk 60 enhances the watertight effect when the bottom surface 42 of first vessel 40 contacts against the soft silica gel layer 64 over the top surface 61 of partition disk 60.

Please refer to FIGS. 28, and 29, which are illustrative views showing a container for accommodating different injection medicines according to a third exemplary embodiment of the present invention. Wherein said first vessel 40 having a modified bottom surface 42 with an additional annular sealing ledge 70 cushioned under the bottom surface 42 of first vessel 40 (as shown in the FIG. 28). And said annular sealing ledge 70 is made of non-toxic soft silica gel material which has an annular groove 71 upwardly created around the rim thereof to serve as a receptacle for the bottom surface 42 of first vessel 40 so that the watertight effect of the partition disk 60 is enhanced by the annular sealing ledge 70 when the bottom surface 42 of first vessel 40 contacts against the soft silica gel layer 64 over the top surface 61 of partition disk 60 (as shown in enlarged view of the FIG. 28).

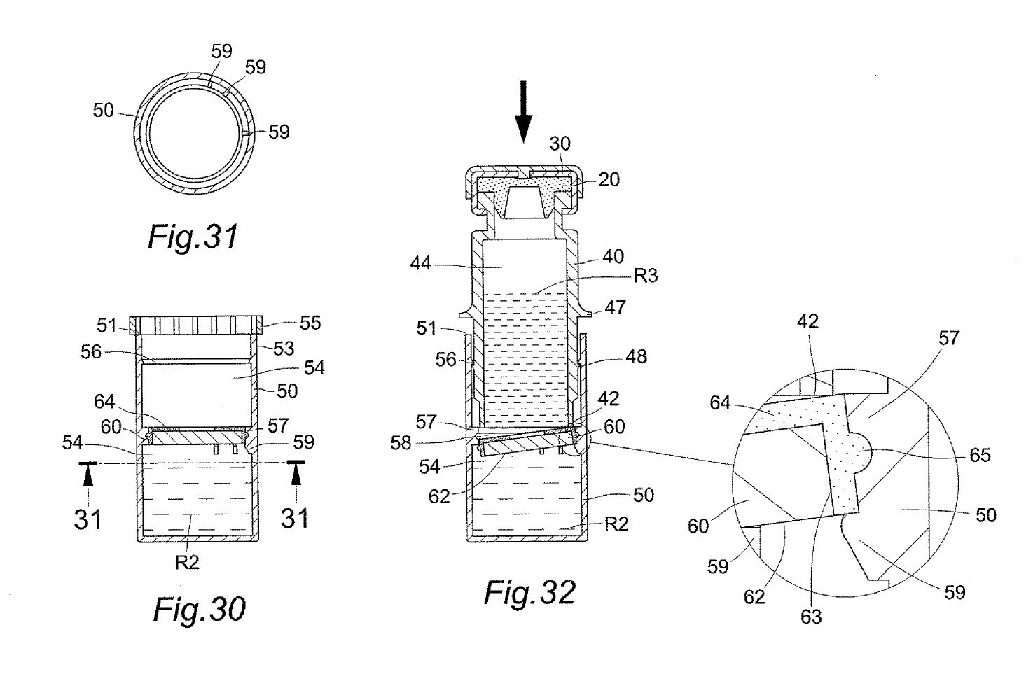

Please refer to FIGS. 30 through 32, which are illustrative views showing a container for accommodating different injection medicines according to a fourth exemplary embodiment of the present invention. The container here includes a modified second holding compartment 54 with additional plural supporting jutties 59 protruded under the retaining ring mount 57 in the second holding compartment 54 of second vessel 50 (as shown in the FIG. 30). The distribution range of the plural supporting jutties 59 is less than one quarter for the circumference of second vessel 50 (as shown in the FIG. 31). The contact points between these plural supporting jutties 59 and the bottom surface 62 function as multiple fulcra for the rocking partition disk 60 (as shown in the FIG. 32) when the bottom surface 42 of first vessel 40 contacts and presses on the top surface 61 of partition disk 60 due to downwards force exerting on the first vessel 40 so that the partition disk 60 will be moved as a rocker to detach off the catching of the retaining ring mount 57.

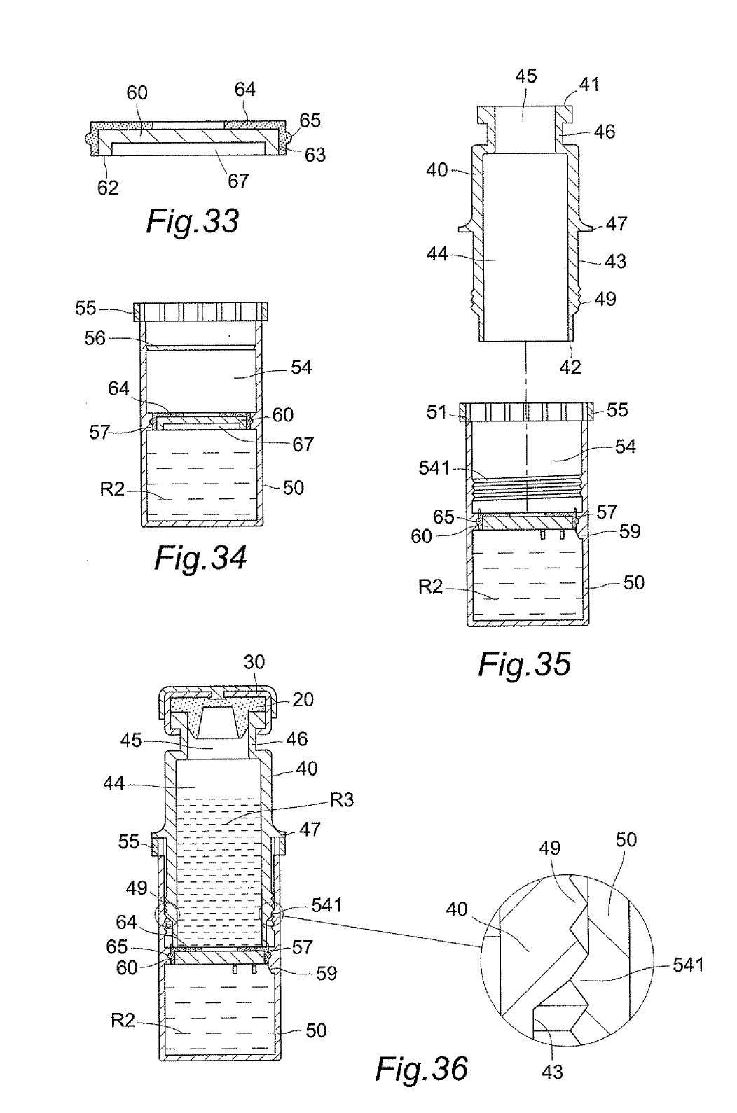

Please refer to FIGS. 33, and 34, which are illustrative views showing a container for accommodating different injection medicines according to a fifth exemplary embodiment of the present invention. The container here includes a modified partition disk 60 with an additional round dent 67 created at the central bottom surface 62 in the partition disk 60 of second vessel 50 (as shown in the FIG. 33). The centrally thinned round dent 67 of the partition disk 60 provides an allowance for inwards constriction to partition disk 60 (as shown in the FIG. 34) when the cylindrical sidewall 63 of partition disk 60 engages on or disengages off the retaining ring mount 57 of second vessel 50 so that an effectively labor-saving operation can be achieved.

Please refer to FIGS. 35, and 36, which are illustrative views showing a container for accommodating different injection medicines according to a sixth exemplary embodiment of the present invention. The container here includes a modified first vessel 40 with an additional male thread 49 created on the periphery of sidewall 43 in the first vessel 40 (as shown in upper view of the FIG. 35) while a modified second vessel 50 with an additional female thread 541 created on the inner wall of sidewall 53 for the second holding compartment 54 of second vessel 50 (as shown in lower view of the FIG. 35) such that the female thread 541 can be screwed by the male thread 49 in corresponding engagement. The corresponding pair of male thread 49 and female thread 541 provides an easy docking means first vessel 40 and second vessel 50 (as shown in the FIG. 36) when the first liquid injection medicament R2 blends with the second liquid injection medicament R3 so that an effectively labor-saving docking operation can be achieved.

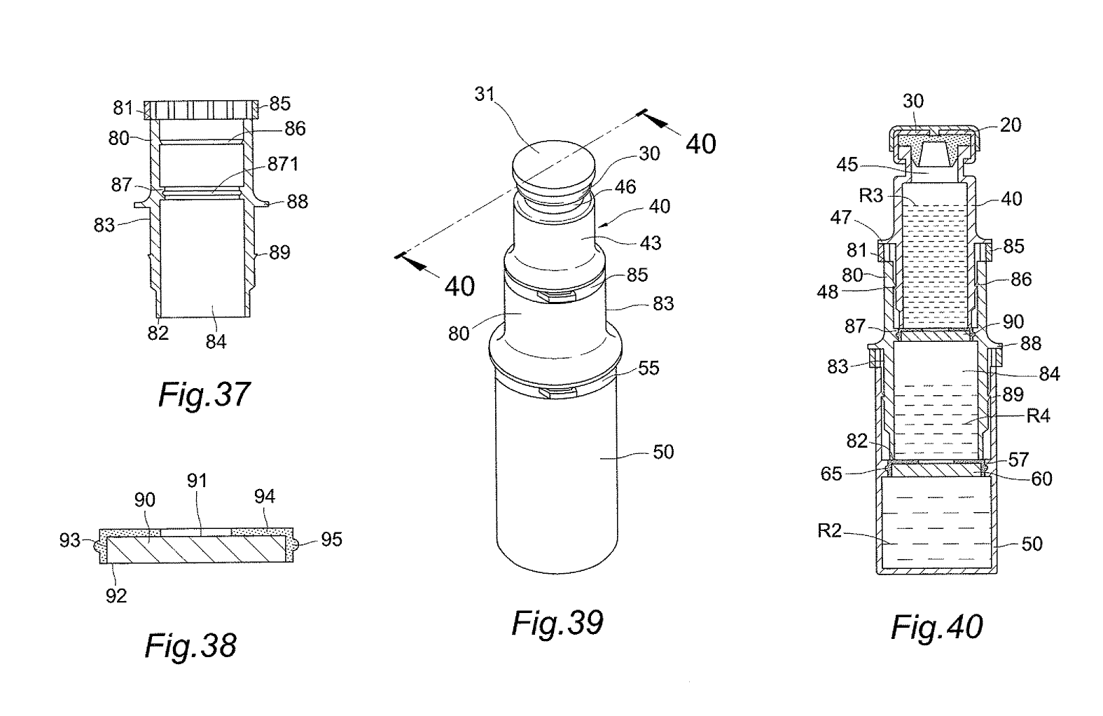

Please refer to FIGS. 37 through 40, which are illustrative views showing a container for accommodating different injection medicines according to a seventh exemplary embodiment of the present invention. The container here includes an additional middle third vessel 80 and a second partition disk 90, wherein said middle third vessel 80, which is an integral hollow cylinder, includes a third holding compartment 84 therein encompassed by an open top surface 81, a bottom surface 82 and a cylindrical sidewall 83 such that the third holding compartment 84 is able to intercommunicate with the top surface 81 and bottom surface 82; the (third holding compartment 84), whose inner diameter thereof is slightly bigger than the outer diameter of the cylindrical sidewall 43 in the first vessel 40 while whose outer diameter thereof is slightly less than the inner diameter of the second holding compartment 54 in the second vessel 50, includes a safety binding hoop 85 with plural raised lining pads applied to inner surface thereof in a recurring pattern disposed over the top surface 81, a docking fluked lip 86 created in the inner wall thereof near the top surface 81, a retaining ring mount 87 created in the inner wall thereof about middle section and a latching groove brim 871 created in the central rim of the retaining ring mount 87, a baffle flange 88 disposed in the middle periphery of the sidewall 83, and a docking barbed rim 89 disposed in the periphery of the sidewall 83 between the baffle flange 88 and bottom surface 82; and said second partition disk 90, which is an integral disk includes a top surface 91 and a bottom surface 92 encompassed by a round sidewall 93, has a soft silica gel layer 94, which wraps over the top surface 91 and sidewall 93, and a latching jut brim 95 outwardly hooped over the soft silica gel layer 94 on the sidewall 93.

Because all the assembling and filling steps as well as the procedure steps in hypodermic injection for all second through seventh exemplary embodiments of the present invention are essentially same as those depicted for the first exemplary embodiments, no extra redundant description are necessary to present here. However, by providing an additional third holding compartment 84 in the middle third vessel 80 for containing third liquid injection medicament R4, three different liquid injection medicaments R can be separately filled in the same injection vial with only single set of conventional septum stopper 20 and crimp cap 30 to achieve expected packaging effect so that not only the demanding quantity of the septum stopper 20 and crimp cap 30 can be economically saved, but also the burden for environmental protection in the wasted septum stopper 20 and crimp cap 30 can be reduced.

What is claimed is:

1. A container for accommodating different injection medicines, comprising:
a first vessel;
a second vessel; and
a partition disk,
wherein said first vessel is an integral hollow cylinder, includes a first holding compartment therein encompassed by a top surface, a bottom surface and a cylindrical sidewall such that the first holding compartment is able to intercommunicate with the top surface and bottom surface; the first holding compartment includes a top opening, a reduced neck disposed near the top surface on the sidewall, a baffle flange disposed in the middle periphery of the sidewall, and a docking barbed rim disposed in the periphery of the sidewall between the baffle flange and bottom surface,
wherein said second vessel is an integral hollow cylinder, includes a first holding compartment therein encompassed by an open top surface, a closed bottom surface and a cylindrical sidewall; the second holding compartment, whose inner diameter is slightly bigger than the outer diameter for the sidewall of the first vessel, includes a safety binding hoop with plural raised lining pads applied to inner surface thereof in a recurring pattern disposed over the top surface, a docking fluked lip created in the inner wall thereof near the top surface, a retaining ring mount created in the inner wall thereof about middle section and a latching groove brim created in the central rim of the retaining ring mount, and
wherein said partition disk is an integral disk includes a top surface and a bottom surface encompassed by a round sidewall, has a soft silica gel layer, which wraps over the top surface and sidewall, and a latching jut brim outwardly hooped over the soft silica gel layer on the sidewall.

2. A container for accommodating different injection medicines as claimed in claim 1, said first vessel further comprising a septum stopper and a crimp cap with a safety cover for received by the top opening of said first vessel.

3. A container for accommodating different injection medicines as claimed in claim 1, wherein an additional annular parapet is further disposed on the outmost edge of the soft silica gel layer over the top surface of the partition disk.

4. A container for accommodating different injection medicines as claimed in claim 1, wherein an additional round dent is further created at the central bottom surface in the partition disk.

5. A container for accommodating different injection medicines as claimed in claim 1, wherein an additional non-toxic soft silica gel annular sealing ledge, which has an annular groove upwardly created around the rim thereof, is further cushioned under the bottom surface of the first vessel.

6. A container for accommodating different injection medicines as claimed in claim 1, wherein additional plural supporting jutties, whose distribution range is less than one quarter for the circumference of second vessel, are further provided under the retaining ring mount in the second holding compartment of the second vessel.

7. A container for accommodating different injection medicines as claimed in claim 1, wherein an additional male thread is further created on the periphery of the sidewall in the first vessel while an additional female thread is further created on the inner wall of the sidewall for the second holding compartment of second vessel.

8. A container for accommodating different injection medicines as claimed in claim 1, further comprises an additional middle third vessel and a second partition disk, wherein said middle third vessel, which is an integral hollow cylinder, includes a third holding compartment therein encompassed by an open top surface, a bottom surface and a cylindrical sidewall such that the third holding compartment is able to intercommunicate with the top surface and bottom surface; the third holding compartment, whose inner diameter thereof is slightly bigger than the outer diameter of the cylindrical sidewall in the first vessel while whose outer diameter thereof is slightly less than the inner diameter of the second holding compartment in the second vessel, includes a safety binding hoop with plural raised lining pads applied to inner surface thereof in a recurring pattern disposed over the top surface, a docking fluked lip created in the inner wall thereof near the top surface, a retaining ring mount created in the inner wall thereof about middle section and a latching groove brim created in the central rim of the retaining ring mount, a baffle flange disposed in the middle periphery of the sidewall, and a docking barbed rim disposed in the periphery of the sidewall between the baffle flange and bottom surface; and said second partition disk, which is an integral disk includes a top surface and a bottom surface encompassed by a round sidewall, has a soft silica gel layer, which wraps over the top surface and sidewall, and a latching jut brim outwardly hooped over the soft silica gel layer on the sidewall.
